(19) United States
(12) Patent Application Publication
(10) Pub. No.: US 2025/0027206 A1
(43) Pub. Date: Jan. 23, 2025

(54) BASE BODY HAVING A COATING

(71) Applicant: HPL TECHNOLOGIES GMBH, Aachen (DE)

(72) Inventors: Dominik DOBRZANSKI, Alsdorf (DE); Tobias Phillip UTSCH, Wetzlar (DE)

(73) Assignee: HPL TECHNOLOGIES GMBH, Aachen (DE)

(21) Appl. No.: 18/717,519

(22) PCT Filed: Dec. 12, 2022
(86) PCT No.: PCT/DE2022/100944

§ 371 Date: Jun. 7, 2024

(30) Foreign Application Priority Data
Dec. 10, 2021 (DE) 10 2021 132 698.2
Sep. 11, 2022 (DE) 10 2022 123 072.4
Oct. 24, 2022 (DE) 10 2022 128 075.6

(51) Int. Cl. C23C 24/10; B23K 26/34; C22C 32/00; C22C 37/00

(52) U.S. Cl. CPC C23C 24/103; B23K 26/34; C22C 32/0047; C22C 37/00

(57) ABSTRACT

The invention relates to a coating for coating a base body comprising iron; and from 10% to 25% by weight of chromium; and from 0.3% to 5% by weight of carbon; and from 0.5% to 15% by weight of vanadium.

The present invention relates to a base body having a coating, a powder material for a coating, and a method for coating a base body.

### BACKGROUND OF THE INVENTION

In industry, such as the automotive industry, weighing up the quality criteria of components against a high level of cost awareness is a constant challenge. Sustainability issues are also becoming increasingly relevant in this equation. This problem is particularly evident in the field of brake disks or other coated parts that are exposed to high stresses.

Brake disks are known in the prior art, for example, as inexpensive components made of gray cast iron. However, one problem with cast brake disks is that they tend to corrode and are not sufficiently resistant to abrasion, which leads to an increase in particulate pollution. The braking process of uncoated cast brake disks, for example, is responsible for around 15% of a vehicle's total particulate emissions. These negative properties can be reduced by coating the brake disk base body. Laser coating processes have generally prevailed over paint coatings because, for example, a functional layer can be produced that achieves higher abrasion resistance, improved corrosion protection and a reduction in particulate emissions.

A process known in the prior art for coating base bodies, such as brake disks, is flame spraying. A welding filler material made of wire or powder is fed into a nozzle. The powder material used is conveyed evenly from the powder hopper and fed through the burner nozzle to the burner flame by a conveyor gas flow. This ensures that melted or fused particles adhere to the surface to be coated. Flame spraying is a comparatively simple and cost-effective process, however, the resulting coatings can have a relatively high porosity, lack a fusion-metallurgical bond with the base body and the gas consumption is high. An alternative is laser cladding [LC], in which, for example, a lower porosity can be achieved with reduced gas consumption. LC is a welding process that uses laser radiation to melt the filler material used, supplied in powder form or wire form.

This powder material is fed to a processing point by means of a carrier gas in a protective gas atmosphere. The processing point is aligned with the base body surface. A laser beam is focused on the processing point and melts the substrate and the powder material passing through the processing point. Unmelted powder particles of the powder material are completely melted in the melting bath. The powder nozzle is moved over the surface by means of movable axes and, in doing so, generates welding beads. The result is a coating that substantially consists of the powder material (i.e., under technical tolerance completely apart from a transition area, the so-called mixing zone). This allows the composition of the powder material to be determined directly, for example, when analyzing the material of the finished coating. The mixing zone, which consists of additional material and substrate material, is located under the coating. The molten powder material collects above the mixing zone and forms the coating.

A person skilled in the art will immediately recognize that a fusion-metallurgical bond is formed regardless of the layer and/or number of plies, wherein this results in a technical improvement over, for example, thermally sprayed layers. The fusion-metallurgical bond leads to mixing between the coating and the substrate. However, because the mixing zone in LC is minimal compared to other welding processes, the coating material can be deduced from the coating.

Extreme high-speed laser cladding [EHLC] emerged from LC. In order to achieve higher feed rates than with LC, with EHLC the welding filler material, provided as a powder, is melted using laser energy before it reaches the substrate, i.e., above the substrate surface. This is achieved by crossing the powder streams to be melted in a so-called powder focus, one or several millimeters above the substrate surface. It should be noted that the EHLC is preferably carried out with the welding device in the earth gravity field above the substrate. However, this may differ in some applications. Above therefore means at least at a distance from the substrate surface. The EHLC process is described, for example, in Schopphoven et. al (“Experimentelle und modelltheoretische Untersuchungen zum Extremen Hochgeschwindigkeits-Laserauftragschweißen”, dissertation at the Fraunhofer Institute for Laser Technology ILT, 2019, published online on the university library's website), and DE 10 2011 100 456 A1.

The powder focus is superimposed with a laser beam so that powder particles pass through the laser beam and are shadowed in the process. This means that not all of the laser's energy reaches the surface of the substrate. The ratio of the total laser power [LP] to the laser power reaching the substrate is usually calculated by a person skilled in the art as the transmittance. By adjusting various process parameters and the resulting degree of transmission, EHLC can be used to achieve a coating as a fusion-metallurgical bond.

The documents WO 2021/007 209 A1 and WO 2021/126 518 A1 disclose coatings. Herein, the expensive carbide formers titanium and niobium and sometimes also chromium are used in large quantities.

### SUMMARY OF THE INVENTION

It is an object of the present invention to provide a base body with a coating having improved properties. In particular, it is an object underlying the present invention to provide a more cost-effective coating for a base body, wherein the coating has favorable properties for its use, and preferably is not excessively prone to cracking and/or pore formation, exhibits a generally high corrosion resistance and bonding of the weld plies, and has a hardness which is advantageous for its use.

These and other objects are achieved by the subject matter of the present independent claims.

### DETAILED DESCRIPTION OF THE INVENTION

The aforementioned objects are achieved in particular by a base body according to the present invention having a coating, a powder material or powder material mixture according to the present invention, a method according to the present invention and an apparatus for coating a base body according to the present invention.

Preferred exemplary embodiments can be found in the dependent claims, and furthermore in the following description and drawings. A person skilled in the art will recognize that each embodiment described below is covered by the subject matter of the appended claims.

The alloy according to the present invention embodied as a coating on a base body comprises iron; and
from 10 wt. % to 25 wt. % of chromium; and
from 0.3 wt. % to 5 wt. % of carbon; and
from 0.5 wt. % to 15 wt. % of vanadium.

It should first be understood that all quantities with regard to the powder material or the powder material mixture used, as well as the coating according to the present invention, are to be understood in the stated quantities in percent by weight [wt. %] in relation to a total weight of the corresponding powder material or the coating. It should also be understood that iron serves as the base material of the powder material in the coating, and is preferably included in balanced form in each case.

Unless explicitly stated otherwise, ordinal numbers used in the preceding and following descriptions are used solely for the purpose of clear differentiation and do not reflect any order or ranking of the designated components. An ordinal number greater than one does not necessarily mean that another such component must be present.

Percentages used in the description above and hereinafter are to be understood as weight percent of the specified alloy, unless a different definition is explicitly stated.

The alloy of the coating that can be formed using the alloy of the welding material shown here has excellent wear resistance and/or abrasion resistance. Carbides, and in some cases borides, formed in the coating are largely responsible for this. At the same time, it is possible to form the coating with this welding material by applying the welding material directly to the base body during the cladding process. The known standard to date is that a mediating primer must be provided. With a single welding material or a single layer on the base body, shorter process times, lower susceptibility to errors, thinner layer thicknesses and possibly a smaller number of plies, i.e., repeated application, can be achieved to produce the (single) layer of the coating.

The result is a coating in the form of a corrosion-resistant hard alloy, wherein the properties of corrosion protection and wear protection are thus combined. The use of different carbide formers with different precipitation kinetics and thus also different distributions leads to good resistance to wear particles (e.g., dirt between the brake disk and brake pad) of various sizes.

In one embodiment, hard material particles are also added to the coating as a component of the powder material, wherein these hard material particles substantially do not participate in the welding process. For example, such hard material particles of a desired grain size are only melted on the surface or only heated during the cladding process.

In a supplementary embodiment, hard material particles are additionally added depending on the ply of a plurality of plies (forming the coating). In this case, although the alloy of the coating is the same throughout, a different quantity of hard material particles is embedded in different plies or in at least one ply, preferably the lowermost (i.e., closest to the base body) ply or a plurality of (neighboring) lowermost plies, including the lowermost ply of all, and preferably no hard material particles are embedded in the uppermost (i.e., outermost) ply or a plurality of (neighboring) uppermost plies, including the uppermost ply of all.

It should be noted that the coating described here can be provided as an alloy of the welding material, for example as wire or powder, wherein the powder material does not necessarily have to have the composition described in each powder particle, possibly even differing greatly if different base materials are combined to form a powder mixture or are combined in-situ. In one embodiment, any desired hard material particles are also blended in, but these are not added to the welding material as non-participating particles.

The term “powder material” or “powder material mixture” as used herein preferably refers to the welding material with which the coating of the base body is produced. It should be understood that the welding material is preferably provided for cladding as a powder material for powder cladding.

The term “balanced” as used herein preferably means that the amount of iron is adjusted accordingly (topping up to 100%) to achieve the stated weight percentages of other constituents, so that the main constituent of a coating proposed herein is an iron-based alloy.

This coating is a cost-effective coating for a base body compared to the coating known from the prior art. This is achieved in particular by using vanadium, and preferably by avoiding relatively expensive components, in particular niobium and/or titanium.

Surprisingly, the present inventors have found that the coating proposed herein additionally has properties favorable to its use and is not excessively prone to cracking and/or pore formation, exhibits a generally high corrosion resistance and good bonding of the welded plies, and has a hardness favorable to its use.

In a preferred embodiment of the base body with the coating, the coating comprises iron; and
preferably from 0.5 to 15.0 wt. % of vanadium; and
preferably at most 4.0 wt. % of niobium; and
preferably furthermore at most 0.35 wt. % of titanium; and
preferably furthermore at most 0.3 wt. % of nickel; and
more preferably from 0.3 to 3.0 wt. % of carbon; and
more preferably from 10 wt. % to 18 wt. % of chromium; and
more preferably from 1.0 to 10 wt. % of manganese; and
more preferably from 0.05 to 1.0 wt. % of molybdenum; and
more preferably from 0.25 to 1.25 wt. % of silicon; and
more preferably at most 0.75 wt. % of tungsten; and
more preferably at most 0.15 wt. % of phosphorus; and
more preferably at most 0.25 wt. % of sulfur; and
more preferably from 0.01 to 0.5 wt. % of nitrogen; and
more preferably 0.01 to 0.09 wt. % of oxygen.

Surprisingly, the present inventors have found that the coating proposed herein can be realized with vanadium. Compared to niobium and/or titanium, vanadium is a relatively inexpensive component.

Vanadium is used in the coating in particular as a carbide former.

The use of vanadium means that more expensive components such as niobium and titanium can be used in significantly smaller quantities. Preferably, the welding material does not contain any niobium or titanium, at least not beyond the usual impurities.

Surprisingly, it has been found that the property profile of corresponding alloys can be precisely customized by the coordinated addition of monocarbide formers such as vanadium. Due to a fine distribution (finely dispersed precipitation of primary vanadium carbide), in conjunction with grain refinement effects, the crack length of the often heavily cracked welding layers can be shortened. Impact wear stress thus no longer leads to immediate chipping. This results in advantages for abrasive and impact wear stresses. Another advantage is the extremely high hardness and high melting point of vanadium carbide, which is in the range of titanium carbide and above tungsten carbide. Vanadium carbide has a hardness of 2950 HV_{0.01} [two thousand, nine hundred and fifty Vickers hardness, with 0.102 kp [one hundred and two thousandths of a kilo-pound] test force and a standardized load time of from 10 s [ten seconds] to 15 s and a melting point of 2830° C. [two thousand, eight hundred and thirty degrees Celsius].

The resulting mixed carbides of type (Cr, Fe) 7C3 have a hardness of from 1700 HV 10 [one thousand seven hundred Vickers hardness] to 2100 HV 10. Boron leads to a hardening of the (Cr, Fe) 7C3 carbides from a content of about 0.6%. The most important hard materials besides Cr7C3 are the chromium carbides Cr3C2 and Cr23C6. Cr7C3 carbides and Cr23C6 carbides, which have a needle-shaped to plate-shaped microstructure, have proven to be particularly effective in abrasive wear.

In addition, the alloying of manganese and silicon not only typically leads to a significant improvement in the welding properties due to the high oxygen affinity and thus to deoxidation, but also to an increase in the wear resistance of the applied coating.

A higher proportion of vanadium increases the hardness of the coating in particular. However, too high a proportion of vanadium can cause the lattice to be excessively tensioned.

It should be noted that the comparisons discussed herein are made to a composition with less or more of the respective element in the coating. It is at least true here that there is less or more of this element due to a corresponding increase or decrease in the iron as a base. Alternatively or additionally, more or less of another of the elements mentioned is present in a quantity that is considerable in the context of the orders of magnitude mentioned. This is explicitly indicated in some examples if the respective element can be used as a substitute. However, it is also within the capabilities of a person skilled in the art, at least on the basis of the explanations provided herein, to use a suitable alloy within the scope of the invention proposed herein, in which the elements are present in a combination which is not listed here as an explicit example.

The more vanadium is used, the more additional carbide formers can be dispensed with, such as niobium and titanium, but also molybdenum. It should be noted that it is not necessary to replace the other carbides in the same quantity because vanadium carbide is very finely distributed and is one of the very high-quality carbides due to its high hardness and high melting point.

Preferably, such a coating comprises at least 0.75 wt. %, more preferably at least 1.0 wt. %, more preferably at least 1.6 wt. %, more preferably at least 2.5 wt. %, and more preferably at least 5.0 wt. % of vanadium.

At the same time, a relatively low proportion of vanadium is advantageous because this reduces the tendency to crack. However, too little vanadium can be disadvantageous because a sufficiently high hardness may not be achieved.

In a further preferred embodiment of the base body with the coating, the coating comprises at most 15 wt. %, preferably at most 12.5 wt. % and more preferably at most 12 wt. %, more preferably at most 10 wt. %, more preferably at most 8 wt. % of vanadium.

In another preferred embodiment of the base body with the coating, the coating comprises: preferably from 0.5 to 15.0 wt. %, more preferably from 0.75 to 15.0 wt. %, more preferably from 1.0 to 15.0 wt. %, more preferably from 1.6 to 15.0 wt. %, more preferably from 2.5 to 15.0 wt. %, more preferably from 5.0 to 15.0 wt. %, more preferably from 0.5 to 12.5 wt. %, more preferably from 0.75 to 12.5 wt. %, more preferably from 1.0 to 12.5 wt. %, more preferably from 1.6 to 12.5 wt. %, more preferably from 2.5 to 12.5 wt. %, more preferably from 5.0 to 12.5 wt. %, more preferably from 0.5 to 12.0 wt. %, more preferably from 0.75 to 12.0 wt. %, more preferably from 1.0 to 12.0 wt. %, more preferably from 1.6 to 12.0 wt. %, more preferably from 2.5 to 12.0 wt. %, and more preferably from 5.0 to 12.0 wt. %, more preferably from 0.5 to 10.0 wt. %, more preferably from 0.75 to 10.0 wt. %, more preferably from 1.0 to 10.0 wt. %, more preferably from 1.6 to 10.0 wt. %, more preferably from 2.5 to 10.0 wt. % and more preferably from 5.0 to 10.0 wt. %, more preferably from 0.5 to 8.0 wt. %, more preferably from 0.75 to 8.0 wt. %, more preferably from 1.0 to 8.0 wt. %, more preferably from 1.6 to 8.0 wt. %, more preferably from 2.5 to 8.0 wt. % and more preferably from 5.0 to 8.0 wt. % of vanadium.

In an advantageous embodiment, the coating comprises a proportion of niobium.

A proportion of niobium is present in the coating as a carbide former.

At the same time, a relatively low proportion of niobium is advantageous in order to keep the costs of the coating low.

In a further preferred embodiment of the base body with the coating, the coating further comprises at most 4.0 wt. % of niobium.

In another preferred embodiment of the base body with the coating, the coating comprises: preferably at most 3.5 wt. %, more preferably at most 3.0 wt. %, more preferably at most 2.0 wt. %, more preferably at most 1.0 wt. %, more preferably at most 0.75 wt. %, more preferably at most 0.5 wt. %, more preferably at most 0.25 wt. %, more preferably at most 0.1 wt. % and more preferably at most 0.01 wt. % of niobium.

In an advantageous embodiment, the coating comprises a proportion of titanium.

A proportion of titanium is present in the coating as a carbide former and/or corrosion protection element.

At the same time, a relatively low proportion of titanium is advantageous in order to keep the costs of the coating low.

In a further preferred embodiment of the base body with the coating, the coating further comprises a maximum of 0.4 wt. % of titanium.

In another preferred embodiment of the base body with the coating, the coating comprises: preferably further at most 0.35 wt. %, more preferably at most 0.25 wt. %, more preferably at most 0.1 wt. % and more preferably at most 0.01 wt. % of titanium.

In an advantageous embodiment, the coating comprises a proportion of nickel.

Nickel in the coating serves in particular to increase corrosion protection.

The higher nickel content also improves weldability. At the same time, a relatively low nickel content is advantageous in order to minimize the proportion of harmful substances and also to comply with modern standards, such as the Reach Regulation.

In a further preferred embodiment of the base body with the coating, the coating further comprises at most 0.5 wt. % of nickel, preferably further at most 0.3 wt. %, further at most 0.2 wt. %, more preferably at most 0.1 wt. % and more preferably at most 0.01 wt. % of nickel.

In an advantageous embodiment, the coating comprises a proportion of carbon.

Carbon in the coating serves in particular as a carbide former.

A higher proportion of carbon can be particularly detrimental to weldability. At the same time, a higher proportion of carbon can favorably increase the hardness.

At the same time, a relatively low carbon content is advantageous in order to improve weldability. A relatively low carbon content also favorably reduces cracking.

In a further preferred embodiment of the base body with the coating, the coating preferably further comprises at least 0.3 wt. % of carbon.

In a further preferred embodiment of the base body with the coating, the coating preferably further comprises at least 0.5 wt. %, more preferably at least 0.75 wt. %, more preferably at least 1.0 wt. % and more preferably at least 1.5 wt. % of carbon.

Such a high proportion of carbon is favorable for austenite formation. It should be noted that a high proportion of the carbon in the powder material reacts during the cladding process and does not end up in the alloy of the coating, for example with penetrated atmospheric oxygen. For example, a carbon content of 0.5 wt. % to 1.5 wt. % is achieved in the alloy of the coating with the aforementioned quantity in the welding material.

In a further preferred embodiment of the base body with the coating, the coating more preferably comprises at most 4.5 wt. %, more preferably at most 3.0 wt. %, more preferably at most 2.5 wt. % and more preferably at most 2.0 wt. % of carbon.

In another preferred embodiment of the base body with the coating, the coating comprises: more preferably from 0.3 to 5 wt. %, more preferably from 0.5 to 5 wt. %, more preferably from 0.75 to 5 wt. %, more preferably from 1.0 to 5 wt. %, more preferably from 1.5 to 5 wt. %, more preferably from 0.3 to 4.5 wt. %, more preferably from 0.5 to 4.5 wt. %, more preferably from 0.75 to 4.5 wt. %, more preferably from 1.0 to 4.5 wt. %, more preferably from 1.5 to 4.5 wt. %, more preferably from 0.3 to 3.0 wt. %, more preferably from 0.5 to 3.0 wt. %, more preferably from 0.75 to 3.0 wt. %, more preferably from 1.0 to 3.0 wt. %, more preferably from 1.5 to 3.0 wt. %, more preferably from 0.3 to 2.5 wt. %, more preferably from 0.5 to 2.5 wt. %, more preferably from 0.75 to 2.5 wt. %, more preferably from 1.0 to 2.5 wt. %, more preferably from 1.5 to 2.5 wt. %, more preferably from 0.3 to 2.0 wt. %, more preferably from 0.5 to 2.0 wt. %, more preferably from 0.75 to 2.0 wt. %, more preferably from 1.0 to 2.0 wt. % and more preferably from 1.5 to 2.0 wt. % of carbon.

In an advantageous embodiment, the coating comprises a proportion of chromium.

Chromium is an important component for corrosion resistance, especially against aqueous solutions, such as (saline) rainwater. In combination with molybdenum, it is particularly effective against pitting corrosion. The lower the proportion, the cheaper the welding material. However, too little chromium can have an immense negative impact on corrosion resistance.

Chromium in the coating effectively prevents the formation of iron oxide, particularly in the case of (low) oxygen exposure-especially when processing under a protective gas atmosphere. A proportion of chromium in the coating is advantageous for increased corrosion protection and as a carbide former. In addition, however, chromium in the proposed welding material is a component for hard phase formation.

A higher proportion of chromium increases the corrosion resistance of the coating in particular.

In a further preferred embodiment of the base body with the coating, the chromium is freely present in the matrix. This is particularly advantageous to ensure corrosion protection. Bound chromium in the form of chromium carbides may not contribute to corrosion protection. A person skilled in the art will recognize that vanadium in the coating proposed here is thus simultaneously used as a sacrifice (sufficiently highly), so that carbon is advantageously bound to vanadium and not to chromium.

In a further preferred embodiment of the base body with the coating, the coating more preferably comprises at least 10 wt. %, more preferably at least 12.5 wt. %, more preferably at least 13 wt. % and more preferably at least 15.0 wt. % of chromium.

A proportion of at least 12.0 wt. % of chromium in the coating is particularly preferred.

In a further preferred embodiment of the base body with the coating, the coating more preferably comprises at most 25 wt. %, more preferably at most 20 wt. % and more preferably at most 18 wt. % of chromium.

In another preferred embodiment of the base body with the coating, the coating more preferably comprises from 10 wt. % to 25 wt. %, more preferably from 12.5 wt. % to 25 wt. %, more preferably from 13 wt. % to 25 wt. %, more preferably from 15.0 wt. % to 25 wt. %, more preferably from 10 wt. % to 20 wt. %, more preferably from 12.5 wt. % to 20 wt. %, more preferably from 13 wt. % to 20 wt. %, more preferably from 15.0 wt. % to 20 wt. %, more preferably from 10 wt. % to 18 wt. %, more preferably from 12.5 wt. % to 18 wt. %, more preferably from 13 wt. % to 18 wt. %, more preferably from 15.0 wt. % to 18 wt. % of chromium.

In an advantageous embodiment, the coating comprises a proportion of manganese.

Manganese in the coating is used in particular to improve weldability, strength and wear resistance, as well as to optimize hardenability.

A pronounced balance of manganese is advantageous in order to avoid higher proportions of brittle phases.

The carbon together with the manganese supports the formation of austenite (face-centered cubic lattice structure of an iron alloy) and thus the desired toughness of the coating. The manganese content is also an effective work hardener.

In a further preferred embodiment of the base body with the coating, the coating more preferably comprises at least 1.0 wt. %, more preferably at least 1.25 wt. % and more preferably at least 1.4 wt. % of manganese.

In a further preferred embodiment of the base body with the coating, the coating more preferably comprises at most 10 wt. %, more preferably at most 7.5 wt. % and more preferably at most 6.5 wt. % of manganese.

In a further preferred embodiment of the base body with the coating, the coating more preferably comprises from 1.0 to 10 wt. %, more preferably from 1.25 to 10 wt. %, more preferably from 1.4 to 10 wt. %, more preferably from 1.0 to 7.5 wt. %, more preferably from 1.25 to 6.5 wt. %, more preferably from 1.4 to 6.5 wt. % and more preferably from 1.4 to 6.5 wt. % of manganese.

In an advantageous embodiment, the coating comprises a proportion of molybdenum.

Molybdenum in the coating is particularly advantageous for improving weldability and fine grain formation.

In addition to the properties described above, molybdenum has the property of being resistant to corrosion from non-oxidizing solutions such as hydrochloric acid, which also occurs in the environment in non-negligible quantities. Molybdenum is also another carbide former.

A higher proportion of molybdenum therefore increases corrosion resistance in particular.

In a further preferred embodiment of the base body with the coating, the coating more preferably comprises at least 0.05 wt. %, more preferably at least 0.1 wt. % and more preferably at least 0.25 wt. % of molybdenum.

In a further preferred embodiment of the base body with the coating, the coating more preferably comprises at most 1.0 wt. %, more preferably at most 0.75 wt. % and more preferably at most 0.6 wt. % of molybdenum.

In a further preferred embodiment of the base body with the coating, the coating more preferably comprises from 0.05 to 1.0 wt. %, more preferably from 0.1 to 1.0 wt. %, more preferably from 0.25 to 1.0 wt. %, more preferably from 0.05 to 0.75 wt. %, more preferably from 0.1 to 0.75 wt. %, more preferably from 0.25 to 0.75 wt. %, more preferably from 0.05 to 0.6 wt. %, more preferably from 0.1 to 0.6 wt. % and more preferably from 0.25 to 0.6 wt. % of molybdenum.

In an advantageous embodiment, the coating comprises a proportion of silicon.

A higher proportion of silicon has the particular advantage of increasing the wear resistance and strength of the coating.

In a further preferred embodiment of the base body with the coating, the coating more preferably comprises at least 0.1 wt. % of silicon.

In a further preferred embodiment of the base body with the coating, the coating more preferably comprises at least 0.25 wt. %, more preferably at least 0.3 wt. %, and more preferably at least 0.5 wt. % of silicon.

In a further preferred embodiment of the base body with the coating, the coating more preferably comprises at most 1.25 wt. %, more preferably at most 1.0 wt. % and more preferably at most 0.7 wt. % of silicon.

In a further preferred embodiment of the base body with the coating, the coating more preferably comprises from 0.25 to 1.25 wt. %, more preferably from 0.3 to 1.25 wt. %, more preferably from 0.5 to 1.25 wt. %, more preferably from 0.25 to 1.0 wt. %, more preferably from 0.3 to 1.0 wt. %, more preferably from 0.5 to 1.0 wt. %, more preferably from 0.25 to 0.7 wt. %, more preferably from 0.3 to 0.7 wt. %, and more preferably from 0.5 to 0.7 wt. % of silicon.

In an advantageous embodiment, the coating comprises a proportion of tungsten.

Even in very small quantities, tungsten is advantageous as a carbide former (e.g., for a high-friction-resistant and/or high-temperature-resistant surface). However, it is particularly advantageous in small quantities as a mixed crystal solidifier and for the high-temperature resistance of the coating.

Tungsten carbides have proven to be an effective hard material additive in the prior art, especially in so-called dual-layer systems. They significantly increase the hardness of a welded layer. The disadvantage is that they make the welding process more difficult because an even distribution of the carbides in the melt must be ensured. In addition, melting of the carbides should be prevented in order to utilize the technological advantage of the carbides and reduce the risk of embrittlement of the matrix. Their high price is also a problem for economic efficiency.

A higher proportion of tungsten has the particular advantage of increasing the heat resistance of the coating. Tungsten also serves favorably as a carbide former. However, a high proportion of tungsten can be uneconomical due to high material costs.

In a further preferred embodiment of the base body with the coating, the coating more preferably comprises at most 0.75 wt. %, more preferably at most 0.6 wt. %, more preferably at most 0.5 wt. %, more preferably at most 0.25 wt. %, more preferably at most 0.05 wt. %, and more preferably at most 0.01 wt. % of tungsten.

In an advantageous embodiment, the coating comprises a proportion of phosphorus.

A relatively low phosphorus content is advantageous because phosphorus is detrimental as a steel pest.

In a further preferred embodiment of the base body with the coating, the coating more preferably comprises at most 0.15 wt. %, more preferably at most 0.1 wt. %, more preferably at most 0.05 wt. %, and more preferably at most 0.25 wt. % of phosphorus.

In one embodiment, the coating comprises a proportion of sulfur.

A relatively low proportion of sulfur is advantageous. A person skilled in the art will recognize that sulfur is bound by manganese.

In a further preferred embodiment of the base body with the coating, the coating more preferably comprises at most 0.25 wt. %, more preferably at most 0.1 wt. % and more preferably at most 0.01 wt. % of sulfur.

In one embodiment, the coating comprises a proportion of nitrogen.

Nitrogen-alloyed steels are increasingly being used in the prior art. However, a person skilled in the art will generally regard nitrogen as a steel pest and minimize the proportion of nitrogen. Nitrogen can be used as an alloying component.

In a further preferred embodiment of the base body with the coating, the coating more preferably comprises at most 0.5 wt. %, more preferably at most 0.25 wt. %, and more preferably at most 0.1 wt. % of nitrogen.

In a further preferred embodiment of the base body with the coating, the coating more preferably comprises at least 0.01 wt. %, more preferably at least 0.02 wt. % and more preferably at least 0.05 wt. % of nitrogen.

In a further preferred embodiment of the base body with the coating, the coating more preferably comprises from 0.01 to 0.5 wt. %, more preferably from 0.02 to 0.5 wt. %, more preferably from 0.05 to 0.5 wt. %, more preferably from 0.01 to 0.25 wt. %, more preferably from 0.02 to 0.25 wt. %, more preferably from 0.05 to 0.25 wt. %, more preferably from 0.01 to 0.1 wt. %, more preferably from 0.02 to 0.1 wt. %, more preferably from 0.05 to 0.1 wt. % of nitrogen.

In one embodiment, the coating comprises a proportion of oxygen.

A relatively low oxygen content is advantageous, as oxygen can lead to embrittlement and other negative properties. It is worth mentioning that some of the other alloy components described may also have a deoxidizing effect. A person skilled in the art will recognize in this respect that oxygen should advantageously be avoided and that other alloy components can also be designed to counteract oxygen contamination.

In a further preferred embodiment of the base body with the coating, the coating more preferably comprises 0.01 to 0.09 wt. % of oxygen.

It should be understood that the coating according to the present invention may be suitable for coating any base body which requires wear protection and corrosion protection. In the context of the present invention, the term base body preferably refers to a component that requires wear protection and corrosion protection.

In a further preferred embodiment of the base body with the coating, the coating is intended for coating a gray cast iron base body, in particular a gray cast iron brake disk.

Grey cast iron base bodies are particularly advantageous as base bodies because they can be produced cost-effectively. However, gray cast iron materials have a very high carbon content and are therefore considered to be relatively difficult to weld. According to the knowledge of the present inventors, gray cast iron bodies are generally not advantageous materials for coating. However, gray cast iron base bodies are used in many applications where wear and temperature play a role, for example in brake disk applications.

Due to their poor corrosion resistance and difficult weldability, gray cast iron base bodies are particularly advantageous for use in the EHLC process and are suitable for coating using the EHLC process. The present inventors have recognized that gray cast iron base bodies can only be welded or coated almost crack-free if a low degree of mixing with the base material and a low thermal load are maintained.

The present inventors have further surprisingly found that the coating proposed herein can be used as a single-ply coating, i.e., can be applied directly to the base body. This significantly simplifies the process for manufacturing coated base bodies and makes it more cost-effective.

In a further preferred embodiment of the base body with the coating, the coating is formed as a single-ply coating.

The term “single-ply coating” as used herein preferably refers to a coating that is applied as a single ply to the base body, wherein a so-called buffer layer [BL] or adhesive layer [AL] has been dispensed with. This does not mean that such a ply is or has necessarily been welded on in a single pass.

It is known to a person skilled in the art that the presence of a single-ply coating can be determined on the basis of a sectional view. Here, metallographic analyses known in the prior art are used. In particular, after preparation and etching under the light microscope, the number of plies can be determined directly by visual inspection.

It should be understood that, in comparison to the coating systems described in the prior art, the single-ply coating consists of the actual functional layer, which is usually referred to as a friction layer [FL] when used in a brake disk and similar applications, and this is not applied to a so-called BL or AL.

A person skilled in the art knows that materials differ in their suitability for welding. One criterion here is the carbon content of the material. In general, the higher the carbon content, the more difficult a material is to weld. In order to weld a layer from or onto a material that is difficult to weld, the prior art therefore recommends first welding on a BL (also known as an AL). A so-called BL or AL made of a material with good weldability is placed between the substrate and the actual weld seam. The BL material is selected in such a way that it can achieve both a fusion metallurgical bond to the substrate and a bond to the overlying layer.

The actual functional layer is then applied. This layer, which in the prior art consists of a ceramic-metal mixture, is referred to below as the friction layer. A friction layer made of resistant material increases the abrasion resistance of brake disks.

The embodiments of the coating in which the coating is formed as a single-ply coating thus represent a departure from the prior art because they dispense with the application of such a BL or AL.

In a further preferred embodiment of the base body with the coating, the coating has a hardness of 350-700 HV_{0.01}.

In particular, the coating according to the invention preferably has a hardness of at least 350 HV_{0.01}, more preferably at least 400 HV_{0.01}, more preferably at least 450 HV_{0.01} and more preferably at least 500 HV_{0.01}.

In particular, the coating according to the invention preferably has a hardness of at most 700 HV_{0.01} and more preferably of at most 600 HV_{0.01}.

A higher hardness has the advantage of improving the wear resistance of the coating. At the same time, excessive hardness can promote undesirable cracking.

It should be noted that in one embodiment the specified values refer to the pure welding material.

The objects described above are also solved by a base body according to the present invention, which is in particular a gray cast iron base body, preferably a gray cast iron brake disk, with a coating according to any one of the preceding claims.

A person skilled in the art will immediately recognize that such a base body can benefit from the coating if it is exposed to increased wear, friction or other mechanical stresses. In particular, the coating according to the invention is advantageous for base bodies which serve as braking devices, for example brake disks. Brake disks are subject to a particularly high degree of wear and corrosion. The coating according to the invention has a particularly favorable effect against wear and corrosion and protects the base body. Another advantage of the coating is that it creates a base body that also achieves a particularly favorable reduction in particulate matter, such as that required by EURO7.

The objects described above are also solved by a powder material for a coating according to the present invention and/or a base body according to the present invention.

The powder material according to the invention is preferably the starting material which is provided for producing a coating. In particular, the powder material can be used in a method according to the present invention to produce a coating. The powder material is provided here as a substance mixture of different components. A person skilled in the art immediately understands that the constituents of the powder material do not change with regard to the constituents of the coating and their respective relative amounts contained, or do not change except for minor impurities from the surrounding environment, for example atmospheric oxygen and/or atmospheric nitrogen. Such an impurity is in the range of less than 0.1 wt. %. In other words, the specified elemental composition does not change between the powder material or powder material mixture as a starting material before the welding process and the welded coating, provided that the process has been suitably controlled, for example as described herein. The contained iron in particular will not (technically) react with oxygen. A person skilled in the art will recognize that the added powder material may not fully participate in the welding reaction or may not be fully consumed. For example, it is common for around 90 wt. % of the powder material supplied to be welded. Depending on the process design, the majority of the excessively fed powder starting material (i.e., corresponding to 10 wt. %, for example) is recycled.

The objects described above are also solved by a method for coating a base body with a coating according to the present invention and/or a powder material according to the present invention, by means of build-up welding, for example LC and/or EHLC at an area rate of at least 850 cm²/min [eight hundred and fifty square centimeters per minute].

It should be understood that an area rate of at least 850 cm²/min makes the coating process particularly economical. In the context of the present invention, an “area rate” is preferably standardized to a layer height of 100 μm [one hundred micrometers].

The present coating can be applied to the base body, for example, using an EHLC process as known in the prior art. Preferably, an area rate of at least 850 cm²/min is achieved with a layer height of 100 μm [one hundred micrometers], which is particularly economical with regard to methods for coating a base body. In particular in embodiments in which the coating according to the invention is designed as a single-ply coating, a significant increase in economic efficiency can already be achieved compared to two-layer systems with similar area rates (850 cm²/min at a layer height of 100 μm), a significant increase in economic efficiency can be achieved because the production of two-ply coatings known in the prior art takes longer due to the correspondingly larger number of plies and/or a necessary retooling of the apparatus for a different powder material. However, it should be understood that the coating according to the present invention is not limited to being formed as a single-ply coating.

The objects described above are also solved by an apparatus for a method for coating a base body according to the present invention. Such a coating apparatus is, for example, designed to provide a base body with a coating according to the present invention by means of a cladding process. Such an apparatus preferably has at least the following components:
at least one welding device for generating a welding beam;
at least one feed device for discharging the welding material; and
a feed actuator for moving the welding beam and/or the
   welding material relative to a base body, wherein, in order to provide a surface of a base body to be coated with the coating, the welding material supplied by the feed device is melted or fused by the welding beam,
   so that the supplied welding material can be bonded to the surface by means of the welding beam, wherein the coating is formed by means of a welding material according to the present invention, wherein preferably the welding beam is generated by a laser, and/or wherein preferably the feed device is a powder nozzle, wherein particularly preferably the coating apparatus is set up to carry out EHLC.

All described embodiments of the present invention exhibit at least one, preferably several, more preferably all of the following features:
a low tendency of the coating to form cracks, for example low or preferably no crack formation with preferably simultaneously increased hardness compared to coatings known in the prior art. Crack formation can be easily checked using methods known to a person skilled in the art, for example by metallographic cross-sectioning, e.g., by dye penetration testing. At the same time, a person skilled in the art is familiar with methods for testing hardness using standardized hardness measurement methods;
high corrosion resistance, which can be determined using methods known to a person skilled in the art, for example by analysis using a salt spray chamber and climatic chamber test in accordance with various standards;
good bonding of the welded plies, which can be determined using methods known to a person skilled in the art, such as metallography and EDX (energy dispersive X-ray spectroscopy), adhesive tensile tests, as well as EDX/SEM [scanning electron microscope] analysis and metallographic cross-sectioning;
a powder efficiency of over 90 wt. %, which can be determined by methods known to a person skilled in the art, for example gravimetric measurement before and after coating;
pores in only a small number, which can be determined by methods known to a person skilled in the art, for example by analysis by means of metallographic cross-sectioning;
a high hardness, which can be determined by methods known to a person skilled in the art, for example an analysis using a standardized hardness measurement method.

### BRIEF DESCRIPTION OF THE DRAWINGS

The present invention is described in greater detail below with reference to the accompanying drawings, from which further features, embodiments and advantages can be derived. In the drawings:

FIG. 1: shows a schematic representation of a coating apparatus;

FIG. 2: shows a micrograph of a coating formed by means of the welding material 1;

FIG. 3a: shows a first micrograph of a coating formed by means of the welding material 1;

FIG. 3b: shows a second micrograph of a coating formed using the welding material 1;

FIG. 4a: shows a photographic image of the brake disk and brake pad according to example 11, on both sides;

FIG. 4b: shows a photographic image of the brake disk and brake lining according to example 12, on both sides;

FIG. 5: shows an energy dispersive X-ray spectroscopy of the micrograph from FIG. 2;

FIG. 6: shows a Vickers hardness measurement on a micrograph with the coating according to FIG. 2;

FIG. 7a: shows the result of a corrosion test on a brake disk with a coating;

FIG. 7b: shows the result of a corrosion test of a brake disk with the coating according to FIG. 2; and

FIG. 8: shows a micrograph through the right-hand brake disk according to FIG. 7b.

### EXAMPLES

### Apparatus According to the Present Invention

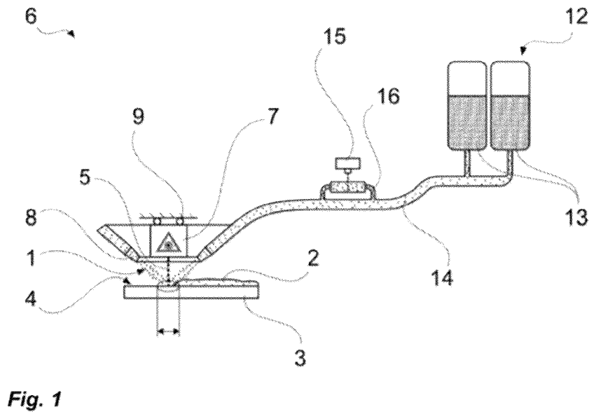

FIG. 1 shows a coating apparatus 6 with a base body 3, for example a brake disk 10, in a schematic view. The coating apparatus 6 shown here comprises (here two) storage containers 12 for the welding material 1, for example for a powder mixed from two powder components 13. The powder is, for example, partly metallic and partly an additive, such as hard material particles, which are used in a friction coating on a brake disk 10, for example. A feed line 14 is connected to the storage container 12 and opens out into a feed device 8, in this case an annular gap nozzle. Here it is optionally shown that a flow measurement 15 is arranged at a bypass line 16 and thus the flow in the feed line 14 (extrapolated from the data of the bypass line 16) can be detected by means of the flow measurement 15. The feed device 8 (here annular gap nozzle) is oriented in such a way that the (here powdered) welding material 1 can be fed into a focus and the focus can be moved in a defined manner by means of a feed actuator 9 (only schematically indicated here for a single feed direction in the image plane from right to left). The coating apparatus 6 also comprises a welding device 7, here for example a laser for LC, preferably for EHLC. The welding device 7 is set up in such a way that the welding material 1 (here by the laser) is melted or fused in the focus so that the welding material 1 (preferably in a weld pool) impinges in the region (as shown) below the focus in the surface 4 of the base body 3 to be coated and thus (after curing) a coating 2 is formed on the workpiece.

### Production of Embodiments

The powder material is used in an EHLC process by means of an apparatus, as shown schematically in FIG. 1, for example, and applied as a coating to a gray cast iron base body.

The hard material particles used, which improve wear protection, are to be replaced here by naturally hard materials. The iron-based alloy is intended to replace the tungsten carbide used as a hard material in the prior art. AISI 316, for example, is used for the BL, if provided. It should be noted that the powder material mentioned here can be applied directly to the surface of the gray cast iron base body to be coated or to a previously applied BL (also referred to as an AL). It is irrelevant whether the respective layer is formed in a single pass or in several passes (i.e. in multiple plies). With suitable process management, the weld plies and thus their number in a layer with a single powder material are no longer recognizable. The number of plies in a layer is determined for a required minimum thickness and/or for a guaranteed overlap due to the track width of the laterally rounded welding beads caused by the process.

In order to carry out various comparative experiments, (practical) examples 1 to 9 of the present coating were prepared and analyzed with regard to their chemical composition. The results of the chemical analysis are shown in Table 2.

TABLE 2
Chemical analysis of welding material applied as a coating to a base body in per cent
by weight

| | B | C | Cr | Fe | Mo | Ni | P | S | Si | V | Mn | N | O | W |
|---|---|---|---|---|---|---|---|---|---|---|---|---|---|---|
| No H | 0.00 | 0.39 | 16.75 | bal | 0.13 | 0.29 | 0.02 | <0.01 | 0.70 | 1.61 | 5.70 | 0.06 | 0.09 | 0.00 |
| No 1 | 0.00 | 0.48 | 16.56 | bal | 0.17 | 0.28 | 0.02 | <0.01 | 0.70 | 2.01 | 5.35 | 0.06 | 10.08 | 0.00 |
| No 2 | 0.00 | 0.57 | 16.36 | bal | 0.20 | 0.27 | 0.02 | <0.01 | 0.69 | 2.41 | 4.99 | 0.06 | 0.08 | 0.00 |
| No 3 | 0.00 | 0.75 | 15.96 | bal | 0.26 | 0.25 | 0.02 | <0.01 | 0.69 | 3.22 | 4.28 | 0.05 | 0.07 | 0.00 |
| No 4 | 0.00 | 1.10 | 15.18 | bal | 0.40 | 0.20 | 0.01 | <0.01 | 0.67 | 4.82 | 2.85 | 0.03 | 0.04 | 0.00 |
| No 5 | 0.00 | 1.28 | 14.78 | bal | 0.46 | 0.18 | 0.01 | <0.01 | 0.67 | 5.63 | 2.14 | 0.02 | 0.03 | 0.00 |
| No 6 | 0.00 | 1.46 | 14.39 | bal | 0.53 | 0.16 | 0.01 | <0.01 | 0.66 | 6.43 | 1.43 | 0.02 | 0.02 | 0.00 |
| No 7 | 0.00 | 0.54 | 17.37 | bal | 0.11 | 0.15 | 0.04 | <0.01 | 0.62 | 1.97 | 6.41 | 0.21 | 0.03 | 0.15 |
| No 8 | 0.00 | 1.02 | 16.69 | bal | 0.22 | 0.16 | 0.03 | <0.01 | 0.54 | 3.94 | 4.81 | 0.16 | 0.02 | 0.30 |
| No 9 | 0.00 | 1.51 | 16.01 | bal | 0.32 | 0.18 | 0.03 | <0.01 | 0.47 | 5.90 | 3.20 | 0.10 | 0.02 | 0.45 |
| No W | 0.00 | 1.99 | 15.33 | bal | 0.43 | 0.19 | 0.02 | <0.01 | 0.39 | 17.87 | 1.60 | 0.05 | 0.01 | 0.60 |

Table 2 shows practical examples No. 1 to No. 9 of the present invention and No. W and No. H as delimitations and not belonging to the invention, which were analyzed for their composition by chemical analysis. The table shows the composition according to elements and in percent by weight. Iron (Fe) is present in balanced (bal) quantities.

### Production of Embodiments According to the Two-Layer Model

In a two-layer model, coatings according to the present invention are applied to the BL (also referred to as AL) as a functional layer (in this case embodied as a friction layer), which comprise a high proportion of titanium carbides. The BL here is AISI 316 steel. The friction layer is the coating proposed herein, namely in this example according to example no. 2 above (see Table 2). Table 3 below shows various examples (No. 10 to No. 13) and compares their properties in use with a gray cast iron brake disk. Table 3 describes the layers and shows the carbide content and the grain size of the carbides in the carbide content. The carbide content in Table 3 refers to carbides that are added to the powder material, which is applied as a friction layer, during the welding process (using EHLC). It should be understood that this does not refer to the carbides that are present in the powder material as described above or that are formed during the welding process. It should be noted that these additional carbides are introduced into the powder focus and are therefore introduced directly into the liquid material. The carbides themselves, provided they have the specified grain size, are not melted because the respective intrinsic melting temperature is significantly higher than the process temperatures. The carbides are available as powder material with the specified grain size or grain size window.

TABLE 3
List of examples of coatings mixed with carbides

| Example | Material | Carbide content | Grain size |
|---|---|---|---|
| No 10 | BL + FL_1 with titanium | 50 wt. % of TiC | 45 to 90 μm |
| | carbide | | |
| No 11 | BL + FL_2 with titanium | 50 wt. % of TiC | 45 to 90 μm |
| | carbide | | |
| No 12 | BL + FL_2 with titanium | 40 wt. % of TiC | 5 to 45 μm |
| | carbide | | |
| No 13 | BL + FL_3 with titanium | about 40% TiC | 45 to 90 μm |
| | carbide | | |

In Table 3, BL stands for buffer layer, which is formed from the AISI 316 steel specified below. In Table 3, FL stands for the functional layer, i.e. in this case the friction layer, which is mixed with the respective carbide, i.e., accounts for 50 wt. % or (in example No 10 and No 11) 60 wt. % in the respective layer. The carbides are TiC [titanium carbide]. Alternatively, TC [tungsten carbide] is used partially or as a partial substitute. The particle size windows are to be regarded approximately as a Gaussian distribution, in which a negligible amount of the powder is smaller than the minimum value and larger than the maximum value of the particle size window. The grain size windows are usually achieved by the manufacturers through sieving. Example product from manufacturers such as Durum Verschleißschutz GmbH, H.C. Starck Tungsten GmbH, Gesellschaft für Wolfram Industries mbH or Höganäs Germany GmbH.

The BL is made of a material commonly referred to as austenitic stainless steel. The alloy in question is 1.4404, also known as 316L or AISI 316, which has very good corrosion resistance due to its high chromium content and high molybdenum content in combination with a low carbon content. The strength in the annealed state is around 600 MPa [six hundred mega-pascals] for large diameters, but can be increased for small sections by cold forming. FL_1 refers to the friction layer, which is made of stainless steel, in this case the alloy 1.4016 or 430L. FL_2 (in examples No 11 and No 12) is the friction layer, which is formed of the same material as the BL. The values are specified in accordance with DIN EN 10095:2018, Annex D. FL_3 is the friction layer (in example No 13), which is formed from the material of example No 2 (see Table 2).

### Test Results

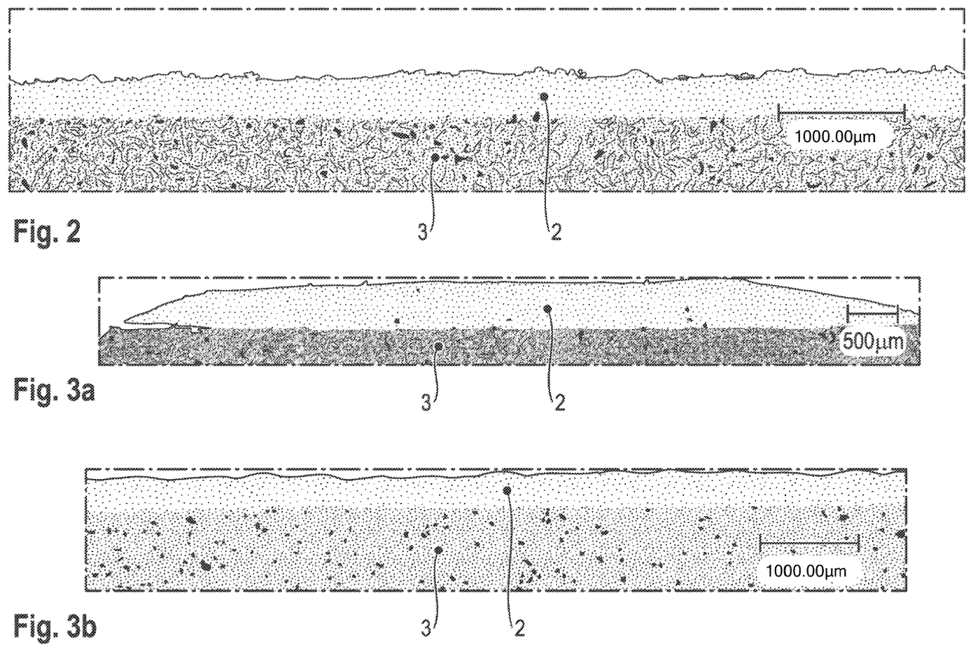

In a further test, as shown in FIG. 2, a micrograph of an embodiment, according to example No 3 in accordance with Table 2 above, of the coating proposed herein was produced, in which the following parameters were achieved:

### Process Parameters:

Beam intensity: approximately 1300 W/mm² [one thousand three hundred watts per square millimeter]
Energy density: 1.3 J/mm³ [thirteen tenths of a joule per cubic millimeter]
Powder mass density: 0.2 mg/mm³ mg/mm³ [one hundred and twelve tenths of a milligram per cubic millimeter]
High-quality coating without layer defects (bonding, pores, cracks)
Hardness approximately 400 to 440 HV_{0.01}
Cr content >12 wt. %

FIG. 3 show micrographs of two further coatings. FIG. 3a shows an embodiment of the coating, which is made from a powder material. FIG. 3a shows, in the result example No. H according to Table 2, an increased hard phase due to an increased chromium content compared to the coating from FIG. 2, which leads to stresses that could lead to cracking and/or spalling. The increased hard phase raises the layer hardness to >450 HV_{0.01}.

FIG. 3b shows an embodiment of the coating according to example No W in Table 2, which is made from a powder material. FIG. 3b shows a reduced hard phase with a high-quality coating result. Due to the reduced hard phase, the hardness is around 350 HV_{0.01}.

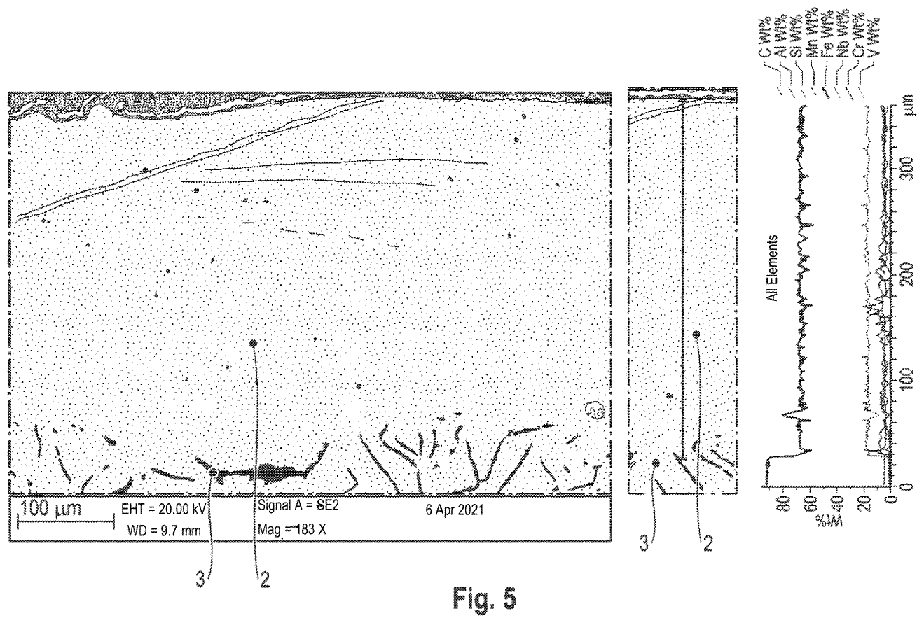

FIG. 5 shows an enlargement of the micrograph from FIG. 2 with the same material combination and in relation to an indication of the length of 100 μm. The cross-section sample was analyzed using energy dispersive X-ray spectroscopy (EDX) [in accordance with DIN ISO 22309 as of November 2015]. The measurement was carried out in the axial direction of the brake disk, from the top down to the base body (see the middle diagram in this regard). Within the coated surface, an almost defect-free coating and a fusion-metallurgical bond were detected, and inhomogeneity was also determined by EDX analysis. The spectroscopic analysis is shown on the right and illustrates the transition from the base body to the coating.

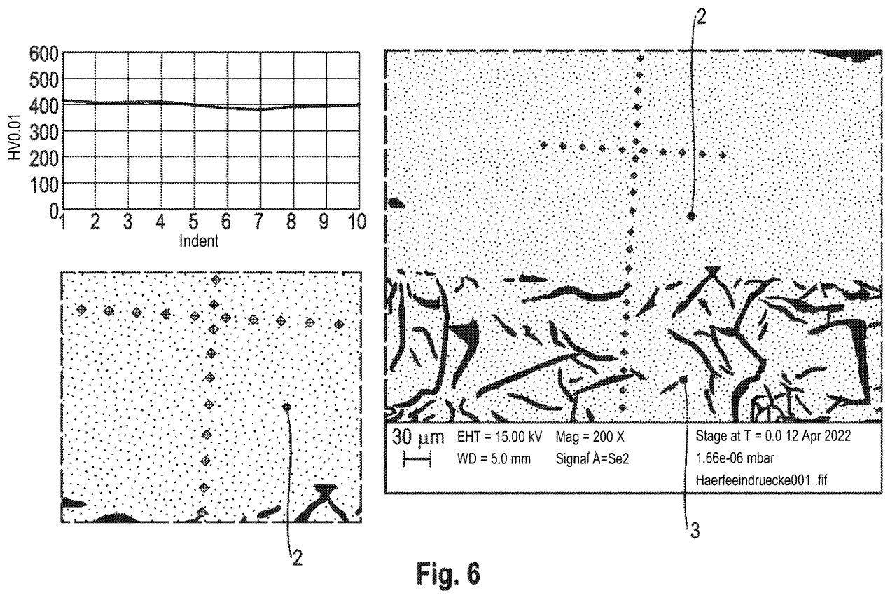

FIG. 6 shows a Vickers hardness measurement [according to EN ISO 6507-1:2018] on a cross-section of a brake disk with a coated surface according to FIG. 2 in relation to an indication of the length of 30 μm in a scanning electron microscope image. A detail of the polished cross-section is shown in the lower left image. The indentations of the Vickers test specimen can be seen in a cross shape in the cross-sectional images on the bottom left and on the right. The hardness test was carried out here axially through the coating and orthogonally, approximately in the center of the coating. The test parameters here were 10 ponds of indentation force with a 15-second increase in force and a holding time of 20 seconds.

The Vickers hardness determined over the horizontal measurement series is shown in the top left image. Here, the Vickers hardness is almost constant with the value 400 HV_{0.01} along the horizontal.

A performance test was carried out for practical examples No 10, No 11, No 12 and No 13 according to Table 3 using the two-layer model. The performance test was carried out in accordance with the so-called WLTP standard. WLTP [Worldwide harmonized Light vehicles Test Procedure] is an international driving cycle standard of the EU, valid from 1 Sep. 2017, in the current version valid on the filing date. The result will be positive for embodiments according to the present invention.

TABLE 4
Overview of the performance of the examples shown in Table 3
Subjective assessment

| Examples | No 10 | | No 11 | | No 12 | | No 13 | |
|---|---|---|---|---|---|---|---|---|
| Front left/right [FL/FR] | FL | FR | FL | FR | FL | FR | FL | FR |
| Evaluation brake disk | − | − | − | − | − | − | + | + |
| MPU on brake | −− | −− | O | O | O | O | + | + |
| pad/brake lining | | | | | | | | |

| Overall rating | − | − | O | + |
|---|---|---|---|---|
| Remarks | | | radial cracks/ | |
| | | | fractures | |
| | | | on the disk | |
| | | | surface | |

Table 4 shows the results of the performance test. The symbol O stands for average performance, the symbol − for poor performance, symbol −− for very poor performance and symbol + for good to very good performance.

The evaluation criteria for the performance of the brake disk are the wear in the form of a profile height variance over the radius of the brake disk, i.e., the distance between the highest and lowest point on the surface of the brake disk. A profile height variance of less than 3 μm [three micrometers] is rated as good, from 7 μm as poor. An average friction coefficient of 0.48 [forty-eight hundredths] is rated here as very good, wherein a pressure of 20 bar [twenty bar], 30 bar and 40 bar was applied on a piston with a diameter of 57 mm [fifty-seven millimeters] to a brake disk with a diameter of 330 mm [three hundred and thirty millimeters]. An average friction value of less than 0.45 is rated here as poor.

The evaluation criteria for the performance of the brake pads is whether grains from the brake disk have seized there, leading to scoring on the surface of the brake disk, and whether scoring has formed on the brake pads themselves. This is done after visual inspection. For comparison, a brake pad in FIG. 6a (example No 12) is shown in a state that is rated as poor in this context. FIG. 6b (example No 13) shows a brake pad in a very good state in this context.

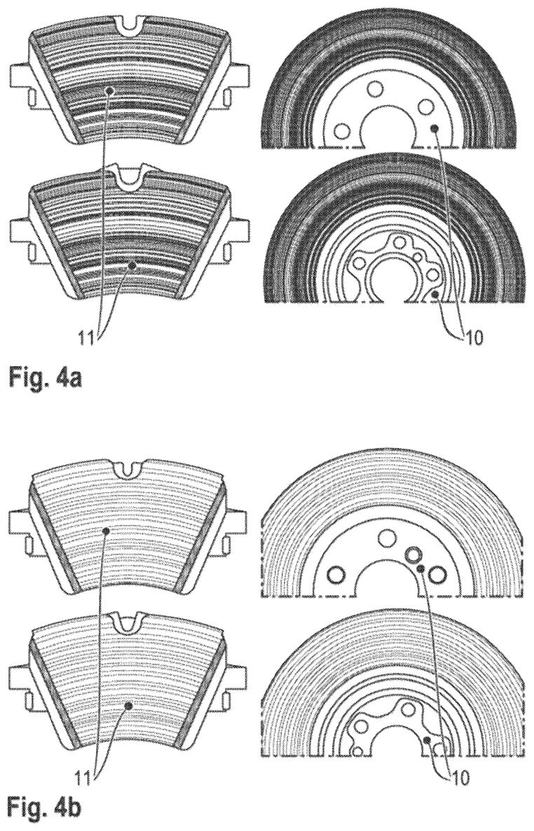

FIG. 4 show photographs of the brake disk and brake pad (each on a brake block) in a brake system. The two rows of illustrations in FIG. 4 show the result on the inside (bottom row) and outside (top row), wherein in each case the right-hand image shows the brake disk and the left-hand image shows the brake pad associated with the side of the brake disk shown on the right. The photographs show the brake system after a driving cycle. Such a driving cycle test can be carried out in accordance with the above-mentioned WLTP [Worldwide harmonized Light vehicles Test Procedure, valid from 1 Sep. 2017]. The result will be positive for embodiments according to the present invention.

In particular, a driving cycle test can be carried out over 7 days. When using a coating according to Example 12 and Example 13 in Table 3, the following results can, in essence, be achieved:

The two rows of illustrations in FIG. 4b show the result on the inside and outside when using a coating according to example No 13. The suitability of the coating according to example No 13 is significantly improved compared to the coating according to example No 12 (see circled areas and damage caused by the arrow in FIG. 4a). The comparisons after visual evaluation of the coatings tested in examples 12 and 13 clearly show that the coating according to example 13 is superior in all tested parameters to the examples shown in the prior art.

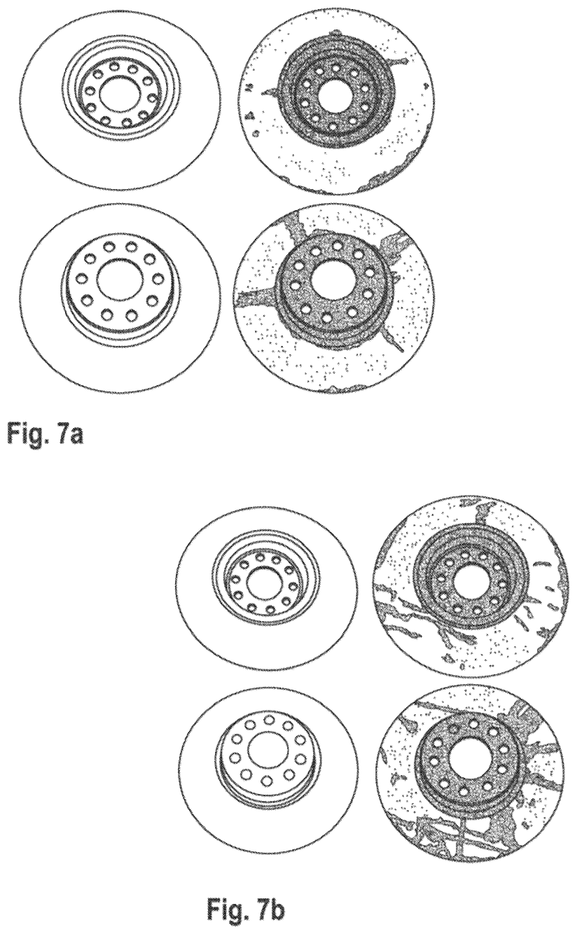

In FIGS. 7, two brake disks are shown from both sides before and after a corrosion resistance test [according to the draft of ISO/DIS 9227:2021], wherein in each case the outside is shown at the top and the inside at the bottom. FIG. 7a on the left shows a brake disk with a coating that is not based on the invention. The cup of the brake disk is free of a coating. This brake disk is a product available on the market and was only tested for its corrosion behavior as a comparison, wherein the aim here was to find out whether the coating proposed here can achieve a similarly good result.

It can be clearly seen here that the pot is subject to significantly more corrosion than the contact surface of the brake disk.

FIG. 7b on the right shows a brake disk with a coating based on the invention, namely in a single-layer structure without BL [buffer layer] and with FL [friction layer] (i.e., applied directly to the base body) according to example No 3 in Table 2. As with the left-hand brake disk, the pot here is also free of a coating, so that it is also subject to similar or the same corrosion as the left-hand brake disk. Both contact surfaces of the brake disks show little to no corrosion in this view.

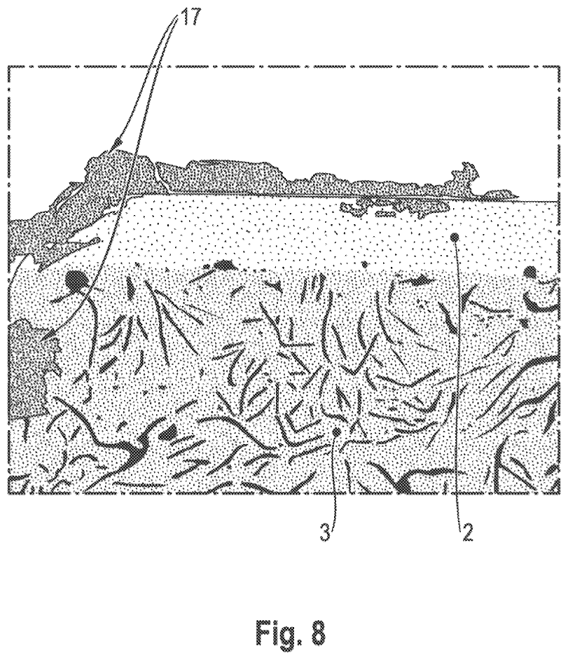

FIG. 8 shows a micrograph of the right-hand brake disk according to FIG. 7b in a microscopic close-up. Here it can be clearly seen that the coating only has surface rust at its upper end (see upper arrow), but that this has not spread into the coating, or only to a very small extent.

At the left-hand end, the edge region of the brake disk, as shown, is not coated and exhibits under-corrosion, so that the base body has been attacked (see lower arrow). However, this under-corrosion is within an acceptable target range, which is below the standards at the time of the corrosion resistance test and within the requirements demanded by the market.

### Further Embodiments

Embodiment 1. Welding material or coating (1) for a cladding process, wherein the welding material or coating (1) comprises iron and the following elements in the stated quantity in per cent by weight:
carbon with 0.3% to 5%;
chromium with 13% to 50%;
manganese with 1.4% to 6.5%;
molybdenum with 0.1% to 0.6%;
silicon with 0.3% to 0.7%; and
vanadium with 1.6% to 12%.

Embodiment 2. Welding material or coating (1) for a cladding process according to embodiment 1, wherein the proportion of carbon is 1.5 wt. % to 2.5 wt. %.

Embodiment 3. Welding material or coating (1) for a cladding process according to embodiment 1 or embodiment 2, wherein the proportion of vanadium is 5 wt. % to 12 wt. %.

Embodiment 4. Welding material or coating (1) for a cladding process according to any one of the preceding embodiments, wherein the welding material or coating (1) further comprises at least one of the following elements in the stated quantity in percent by weight:
boron with less than 0.01%, preferably 80 ppm to 100 ppm;
tungsten with less than 0.75%,
   wherein the remainder is preferably formed by iron and unavoidable impurities.

Embodiment 5. Welding material or coating (1) for a cladding process according to any one of the preceding embodiments, wherein the welding material (1) is provided as a powder for powder cladding.

Embodiment 6. Welding material or coating (2) for a base body (3), wherein a surface (4) of a base body (3) to be coated can be provided with the coating (2) by bonding a supplied welding material (1) to the surface (4) by means of a welding beam (5), wherein the coating (2) is formed by means of a welding material (1) according to any one of the preceding embodiments under a protective gas atmosphere.

Embodiment 7. Method for cladding, wherein a surface (4) of a base body (3) to be coated is provided with a coating (2) by bonding a supplied welding material (1) to the surface (4) by means of a welding beam (5), wherein the welding material (1) is formed according to either one of embodiments 1 or 2, wherein a coating (2) according to embodiment 6 is preferably produced during the cladding process under a protective gas atmosphere.

Embodiment 8. Coating apparatus (6) for providing a base body (3) with a coating (2) by means of a cladding process, comprising at least the following components:
at least one welding device (7) for generating a welding beam (5);
at least one feed device (8) for discharging the welding material or coating (1); and
a feed actuator (9) for moving the welding beam (5) and/or the welding material or coating (1) relative to a base body (3), wherein the coating (2) is applied to a surface (4) of a base body (3) to be coated, the welding material (1) supplied by the feed device (8) is melted or fused by the welding beam (5), so that the supplied welding material (1) can be bonded to the surface (4) by means of the welding beam (5), wherein the coating (2) is formed by means of a welding material (1) according to any one of embodiment 1 to embodiment 5, wherein preferably the welding beam (5) is generated by a laser, and/or wherein preferably the feed device (8) is a powder nozzle, wherein particularly preferably the coating apparatus (6) is set up for carrying out extreme high-speed laser cladding [EHLC].

Embodiment 9. A base body (3) with a coating (2), wherein the coating (2) is produced by means of a method according to embodiment 7 or embodiment 3, wherein preferably the coated surface (4) is a partial surface of the base body (3).

Embodiment 10. A base body (3) according to claim 9, wherein the base body (3) is a brake disk (10), wherein preferably at least one, particularly preferably only the surface (4) to be coated is a friction surface for a braking engagement of a braking means (11).

Embodiment 11. A base body having a coating, the coating comprising iron; and from 10 wt. % to 50 wt. % of chromium; and from 0.3 to 5 wt. % of carbon; and from 0.5 wt. % to 15 wt. % of vanadium.

Embodiment 12. The base body according to embodiment 11, the coating comprising iron; and
preferably from 0.5 to 15.0 wt. % of vanadium; and
preferably at most 4.0 wt. % of niobium; and
preferably furthermore at most 0.35 wt. % of titanium; and
preferably furthermore at most 0.3 wt. % of nickel; and
more preferably from 0.3 to 3.0 wt. % of carbon; and
more preferably from 10 wt. % to 30 wt. % of chromium; and
more preferably from 1.0 to 10 wt. % of manganese; and
more preferably from 0.05 to 1.0 wt. % of molybdenum; and
more preferably from 0.25 to 1.25 wt. % of silicon; and
more preferably at most 0.75 wt. % of tungsten; and
more preferably at most 0.15 wt. % of phosphorus; and
more preferably at most 0.25 wt. % of sulfur; and
more preferably from 0.01 to 0.5 wt. % of nitrogen; and
more preferably 0.01-0.09 wt. % of oxygen.

Embodiment 3. A base body according to any one of the preceding embodiments, wherein the coating comprises at most 15.0 wt. %, preferably at most 12.5 wt. % and more preferably at most 12 wt. % of vanadium.

Embodiment 14. A base body according to any one of the preceding embodiments, wherein the coating preferably comprises from 0.5 to 15.0 wt. %, more preferably from 0.75 to 15.0 wt. %, more preferably from 1.0 to 15.0 wt. %, more preferably from 1.6 to 15.0 wt. %, more preferably from 2.5 to 15.0 wt. %, more preferably from 5.0 to 15.0 wt. %, more preferably from 0.5 to 12.5 wt. %, more preferably from 0.75 to 12.5 wt. %, more preferably from 1.0 to 12.5 wt. %, more preferably from 1.6 to 12.5 wt. %, more preferably from 2.5 to 12.5 wt. %, more preferably from 5.0 to 12.5 wt. %, more preferably from 0.5 to 12.0 wt. %, more preferably from 0.75 to 12.0 wt. %, more preferably from 1.0 to 12.0 wt. %, more preferably from 1.6 to 12.0 wt. %, more preferably from 2.5 to 12.0 wt. % and more preferably from 5.0 to 12.0 wt. % of vanadium

Embodiment 15. A base body according to any one of the preceding embodiments, wherein the coating further comprises at most 4.0 wt. % of niobium.

Embodiment 16. A base body according to any one of the preceding embodiments, wherein the coating preferably comprises at most 3.5 wt. %, more preferably at most 3.0 wt. %, more preferably at most 2.0 wt. %, more preferably at most 1.0 wt. %, more preferably at most 0.75 wt. %, more preferably at most 0.5 wt. %, more preferably at most 0.25 wt. %, more preferably at most 0.1 wt. % and more preferably at most 0.01 wt. % of niobium.

Embodiment 17. A base body according to any one of the preceding embodiments, wherein the coating further comprises at most 0.4 wt. % of titanium.

Embodiment 18. A base body according to any one of the preceding embodiments, wherein the coating preferably further comprises at most 0.35 wt. %, more preferably at most 0.25 wt. %, more preferably at most 0.1 wt. % and more preferably at most 0.01 wt. % of titanium.

Embodiment 19. A base body according to any one of the preceding embodiments, wherein the coating preferably further comprises at most 0.3 wt. %, further at most 0.2 wt. %, more preferably at most 0.1 wt. % and more preferably at most 0.01 wt. % of nickel.

Embodiment 20. A base body according to any one of the preceding embodiments, wherein the coating preferably further comprises at least 0.3 wt. % of carbon.

Embodiment 21. A base body according to any one of the preceding embodiments, wherein the coating preferably further comprises at least 0.5 wt. %, more preferably at least 0.75 wt. %, more preferably at least 1.0 wt. % and more preferably at least 1.5 wt. % of carbon.

Embodiment 22. A base body according to any one of the preceding embodiments, wherein the coating more preferably comprises at most 4.5 wt. %, more preferably at most 3.0 wt. %, more preferably at most 2.5 wt. % and more preferably at most 2.0 wt. % of carbon

Embodiment 23. A base body according to any one of the preceding embodiments, wherein the coating more preferably comprises from 0.3 to 5 wt. %, more preferably from 0.5 to 5 wt. %, more preferably from 0.75 to 5 wt. %, more preferably from 1.0 to 5 wt. %, more preferably from 1.5 to 5 wt. %, more preferably from 0.3 to 4.5 wt. %, more preferably from 0.5 to 4.5 wt. %, more preferably from 0.75 to 4.5 wt. %, more preferably from 1.0 to 4.5 wt. %, more preferably from 1.5 to 4.5 wt. %, more preferably from 0.3 to 3.0 wt. %, more preferably from 0.5 to 3.0 wt. %, more preferably from 0.75 to 3.0 wt. %, more preferably from 1.0 to 3.0 wt. %, more preferably from 1.5 to 3.0 wt. %, more preferably from 0.3 to 2.5 wt. %, more preferably from 0.5 to 2.5 wt. %, more preferably from 0.75 to 2.5 wt. %, more preferably from 1.0 to 2.5 wt. %, more preferably from 1.5 to 2.5 wt. %, more preferably from 0.3 to 2.0 wt. %, more preferably from 0.5 to 2.0 wt. %, more preferably from 0.75 to 2.0 wt. %, more preferably from 1.0 to 2.0 wt. % and more preferably from 1.5 to 2.0 wt. % of carbon.

Embodiment 24. A base body according to any one of the preceding embodiments, wherein the coating more preferably comprises at least 10 wt. %, more preferably at least 12.5 wt. %, more preferably at least 13 wt. % and more preferably at least 15.0 wt. % of chromium.

Embodiment 25. A base body according to any one of the preceding embodiments, wherein the coating more preferably comprises at most 50 wt. %, more preferably at most 40 wt. % and more preferably at most 30 wt. % of chromium.

Embodiment 26. A base body according to any one of the preceding embodiments, wherein the coating is more preferably from 10 wt. % to 50 wt. %, more preferably from 12.5 wt. % to 50 wt. %, more preferably from 13 wt. % to 50 wt. %, more preferably from 15.0 wt. % to 50 wt. %, more preferably from 10 wt. % to 40 wt. %, more preferably from 12.5 wt. % to 40 wt. %, more preferably from 13 wt. % to 40 wt. %, more preferably from 15.0 wt. % to 40 wt. %, more preferably from 10 wt. % to 30 wt. %, more preferably from 12.5 wt. % to 30 wt. %, more preferably from 13 wt. % to 30 wt. % and more preferably from 15.0 wt. % to 30 wt. % of chromium.

Embodiment 27. A base body according to any one of the preceding embodiments, wherein the coating more preferably comprises at least 1.0 wt. %, more preferably at least 1.25 wt. % and more preferably at least 1.4 wt. % of manganese.

Embodiment 28. A base body according to any one of the preceding embodiments, wherein the coating more preferably comprises at most 10 wt. %, more preferably at most 7.5 wt. % and more preferably at most 6.5 wt. % of manganese.

Embodiment 29. A base body according to any one of the preceding embodiments, wherein the coating more preferably comprises from 1.0 to 10 wt. %, more preferably from 1.25 to 10 wt. %, more preferably from 1.4 to 10 wt. %, more preferably from 1.0 to 7.5 wt. %, more preferably from 1.25 to 6.5 wt. %, more preferably from 1.4 to 6.5 wt. % and more preferably from 1.4 to 6.5 wt. %, of manganese.

Embodiment 30. A base body according to any one of the preceding embodiments, wherein the coating more preferably comprises at least 0.05 wt. %, more preferably at least 0.1 wt. % and more preferably at least 0.25 wt. % of molybdenum.

Embodiment 31. A base body according to any one of the preceding embodiments, wherein the coating more preferably comprises at most 1.0 wt. %, more preferably at most 0.75 wt. % and more preferably at most 0.6 wt. % of molybdenum.

Embodiment 32. A base body according to any one of the preceding embodiments, wherein the coating more preferably comprises from 0.05 to 1.0 wt. %, more preferably from 0.1 to 1.0 wt. %, more preferably from 0.25 to 1.0 wt. %, more preferably from 0.05 to 0.75 wt. %, more preferably from 0.1 to 0.75 wt. %, more preferably from 0.25 to 0.75 wt. %, more preferably from 0.05 to 0.6 wt. %, more preferably from 0.1 to 0.6 wt. % and more preferably from 0.25 to 0.6 wt. % of molybdenum.

Embodiment 33. A base body according to any one of the preceding embodiments, wherein the coating more preferably comprises at least 0.1 wt. % of silicon

Embodiment 34. A base body according to any one of the preceding embodiments, wherein the coating more preferably comprises at least 0.25 wt. %, more preferably at least 0.3 wt. %, and more preferably at least 0.5 wt. % of silicon

Embodiment 35. A base body according to any one of the preceding embodiments, wherein the coating more preferably comprises at most 1.25 wt. %, more preferably at most 1.0 wt. % and more preferably at most 0.7 wt. % of silicon

Embodiment 36. A base body according to any one of the preceding embodiments, wherein the coating more preferably comprises from 0.25 to 1.25 wt. %, more preferably from 0.3 to 1.25 wt. %, more preferably from 0.5 to 1.25 wt. %, more preferably from 0.25 to 1.0 wt. %, more preferably from 0.3 to 1.0 wt. %, more preferably from 0.5 to 1.0 wt. %, more preferably from 0.25 to 0.7 wt. %, more preferably from 0.3 to 0.7 wt. %, and more preferably from 0.5 to 0.7 wt. % of silicon.

Embodiment 37. A base body according to any one of the preceding embodiments, wherein the coating more preferably comprises at most 0.75 wt. %, more preferably at most 0.6 wt. %, more preferably at most 0.5 wt. %, more preferably at most 0.25 wt. %, more preferably at most 0.05 wt. %, and more preferably at most 0.01 wt. % of tungsten.

Embodiment 38. A base body according to any one of the preceding embodiments, wherein the coating more preferably comprises at most 0.15 wt. %, more preferably at most 0.1 wt. %, more preferably at most 0.05 wt. %, more preferably at most 0.25 wt. %, and more preferably at most 0.15 wt. % of phosphorus.

Embodiment 39. A base body according to any one of the preceding embodiments, wherein the coating more preferably comprises at most 0.25 wt. %, more preferably at most 0.1 wt. % and more preferably at most 0.01 wt. % of sulfur.

Embodiment 40. A base body according to any one of the preceding embodiments, wherein the coating more preferably comprises at most 0.5 wt. %, more preferably at most 0.25 wt. %, and more preferably at most 0.1 wt. % of nitrogen.

Embodiment 41. A base body according to any one of the preceding embodiments, wherein the coating more preferably comprises at least 0.01 wt. %, more preferably at least 0.02 wt. % and more preferably at least 0.05 wt. % of nitrogen.

Embodiment 42. A base body according to any one of the preceding embodiments, wherein the coating is more preferably from 0.01 to 0.5 wt. %, more preferably from 0.02 to 0.5 wt. %, more preferably from 0.05 to 0.5 wt. %, more preferably from 0.01 to 0.25 wt. % by weight, more preferably from 0.02 to 0.25 wt. %, more preferably from 0.05 to 0.25 wt. %, more preferably from 0.01 to 0.1 wt. %, more preferably from 0.02 to 0.1 wt. %, more preferably from 0.05 to 0.1 wt. % of nitrogen.

Embodiment 43. A base body according to any one of the preceding embodiments, wherein the coating more preferably comprises from 0.01 to 0.09 wt. % of oxygen.

Embodiment 44. A base body according to any one of the preceding embodiments, wherein the coating comprises at least 35 wt. %, preferably at least 40 wt. %, more preferably at least 50 wt. % of carbides.

Embodiment 45. The base body according to embodiment 44, wherein the carbides are selected from titanium carbides and tungsten carbides.

Embodiment 46. A base body according to embodiment 45, wherein a titanium carbide content comprises at least 35 wt. %, preferably at least 40 wt. %, more preferably at least 50 wt. %.

Embodiment 47. A base body according to any one of the preceding embodiments for coating a gray cast iron base body, for example a Grey cast iron brake disk.

Embodiment 48. A base body according to any one of the preceding embodiments, wherein the coating is formed as a single-ply coating.

Embodiment 49. A base body according to any one of the preceding embodiments, wherein the coating has a hardness of 350-700 HV_{0.01}.

Embodiment 50. A base body, for example gray cast iron base body, preferably gray cast iron brake disk, with a coating according to any one of the preceding embodiments.

Embodiment 51. A powder material or powder material mixture for a coating according to any one of the preceding embodiments.

Embodiment 52. A method for coating a base body with a coating as per one of the preceding embodiments and/or a powder material or powder material mixture according to any one of the preceding embodiments by means of cladding, for example laser cladding [LC] and/or extremely high-speed laser cladding [EHLC] at an area rate of at least 850 cm²/min.

Embodiment 53. An apparatus for a method for coating a base body according to any one of the preceding embodiments, wherein the method is preferably a method according to embodiment 52.

The features and combinations of features of the present invention disclosed in the description, claims, examples and/or figures may be essential to the invention either individually or in any combination.

### Materials and Methods

### Creation of Micrographs

The coating quality can be assessed using micrographs. Large sections are cut out of the coated base bodies, for example coated brake disks, using a manual cutting machine. In a water-cooled cutting machine, pieces around five millimeters thick, which contain the entire coated surface, are cut out of these sections. These pieces are cut out as far away as possible from the first cut edges to ensure that no sample affected by heat is analyzed. The separated samples are embedded in Bakelite in a hot embedding press and then ground and polished in several steps. Lastly, images of the coating are taken under a light microscope at 200× magnification.

### Evaluation of the Layer/Welding Quality

Evaluation of the Bond to the Base Material with the Aim of not Creating any Bonding Defects

The coating is always assessed in principle by microscopically analyzing a micrograph of a cross-section through the layers. The micrographs serve as the basis for several analyses. The most important of these is the evaluation of the bond. To evaluate the bond, the samples in relevant areas (for example at the radial ends of the coating) are compared with reference samples and can be categorized, for example according to a grading system.

Evaluation after Crack Formation with the Aim of Achieving Freedom from Cracks

Cracks in the coating are a point of attack for corrosion. They form a passage in the coating into the layer below. Due to their position above the stainless cast iron, cracks in the AL are an exclusion criterion. Their appearance in the friction layer is less critical as long as the resulting cracks do not move through the AL.

As with the bond, the cracks are checked by comparing micrographs with reference samples and are categorized in the same way as the bond. All images used as reference are from samples in which both chromium carbides and tungsten carbides were used as hard materials.

Evaluation of Pore Formation with the Aim of Achieving a High Density

To test the density within the coating, an optical analysis was carried out on the basis of VDI guideline 3405. If pores can be recognized in a micrograph, for example due to gas inclusions or unmelted and/or partially melted powder particles, this has a negative effect on the density (i.e., the proportion of homogeneously melted powder particles) of the coating and therefore on the subsequent strength of the coating. Low to no pore formation is therefore to be favored.

### Determination of Hardness

The hardness is measured using the Vickers small load hardness measurement (HV_{0.01}) in accordance with the DIN EN ISO 6507-1 standard. At least five measurements are taken along the surface to assess the hardness. The measurements are at least one millimeter apart. The mean value is calculated from these. In addition, the hardness curve on a fully coated brake disk is investigated during the detailed tests.

### Determination of Corrosion Resistance

To check the corrosion resistance, a corresponding test according to the draft of ISO/DIS 9227:2021 with a duration of 240 hours in a climatic chamber: according to the temperature cycle plan: 6 cycles of 24 hours and then a non-destructive (first) optical evaluation of the coating was carried out. If there are no clear differences to a reference coating, a destructive test is carried out and a micrograph is created.

### Determination of Layer Height

The average layer height is determined by a metallographer using microscopic images of the micrograph. The average layer height is determined over at least five individual measurements in a micrograph. For this purpose, measurements are carried out in the center of the coating in order to ignore the retraction and extension areas of the coating as far as possible.

### LIST OF REFERENCE NUMBERS

1 Welding material
2 Coating
3 Base body
4 Surface to be coated
5 Welding beam
6 Coating apparatus
7 Welding device
8 Feed device
9 Feed actuator
10 Brake disk
11 Braking means
12 Storage container
13 Powder component
14 Feed line
15 Flow measurement
16 Bypass line
17 Surface rust

1-16. (canceled)

17. Base body with a coating, the coating comprising
iron; and
from 10 wt. % to 25 wt. % of chromium; and
from 0.3 wt. % to 5 wt. % of carbon; and
0.5 wt. % to 15 wt. % of vanadium.

18. Base body according to claim 17, wherein the coating further comprises at most 0.5 wt. %, preferably 0.3 wt. %, more preferably at most 0.2 wt. %, more preferably at most 0.1 wt. % and more preferably at most 0.01 wt. % of nickel.

19. Base body according to claim 17, wherein the coating further comprises at least 10 wt. %, preferably at least 12.5 wt. %, more preferably at least 13 wt. % and more preferably at least 15.0 wt. % of chromium.

20. Base body according to claim 17, wherein the coating further comprises at least 1.0 wt. %, preferably at least 1.25 wt. % and more preferably at least 1.4 wt. % of manganese.

21. Base body according to claim 17, wherein the coating further comprises at least 0.1 wt. % of silicon.

22. Base body according to claim 17, wherein the coating further comprises at most 0.75 wt. %, preferably at most 0.6 wt. %, more preferably at most 0.5 wt. %, more preferably at most 0.25 wt. %, more preferably at most 0.05 wt. %, and more preferably at most 0.01 wt. % of tungsten.

23. Base body according to claim 17, wherein the coating further comprises at most 0.15 wt. %, preferably at most 0.1 wt. %, more preferably at most 0.05 wt. %, more preferably at most 0.25 wt. %, and more preferably at most 0.15 wt. % of phosphorus.

24. Base body according to claim 17, wherein the coating comprises at least 35 wt. %, preferably at least 40 wt. %, more preferably at least 50 wt. % of carbides.

25. Base body according to claim 24, wherein the carbides are selected from titanium carbides and/or tungsten carbides.

26. Base body according to claim 24, wherein a proportion of titanium carbide comprises at least 35 wt. %, preferably at least 40 wt. %, more preferably at least 50 wt. %.

27. Base body according to claim 17 for coating a gray cast iron base body, preferably a gray cast iron brake disk.

28. Base body according to claim 17, wherein the coating is formed as a single-ply coating.

29. Base body according to claim 17, wherein the coating has a hardness of 350 HV_{0.01} to 700 HV_{0.01}.

30. Base body, preferably gray cast iron base body, preferably gray cast iron brake disk, with a coating according to claim 17.

31. Powder material or powder material mixture for a base body with a coating according to claim 17.

32. Method for coating a base body with a coating according to claim 17 and/or a powder material or powder material mixture by means of cladding, preferably laser cladding and/or extremely high-speed laser cladding [EHLC], preferably at an area rate of at least 850 cm²/min.
